(19) United States
(12) Patent Application Publication
(10) Pub. No.: US 2013/0111740 A1
(43) Pub. Date: May 9, 2013

(54) APPARATUS FOR ALIGNING WORKPIECES AND ALIGNMENT ASSEMBLY

(71) Applicants: William Arthur Richard, Aurora (CA); Yoshihiro Tanabe, North York (CA)

(72) Inventors: William Arthur Richard, Aurora (CA); Yoshihiro Tanabe, North York (CA)

(73) Assignee: GENERAL CONVEYOR INC., Aurora (CA)

(21) Appl. No.: 13/292,435

(22) Filed: Nov. 9, 2011

(51) Int. Cl. B23P 19/00

(52) U.S. Cl. 29/700

(57) ABSTRACT

An apparatus for aligning a ferromagnetic workpiece is provided. The apparatus includes a rotatable element having a surface, a holding unit and rare-earth magnet. The holding unit holds ferromagnetic workpieces, which are for engaging with the rare earth magnet. An alignment assembly for aligning a ferromagnetic workpiece is also provided. The alignment assembly includes a support member, a first bar and a second bar. The second bar urges the cap closer to the axis relative to the first bar to cause the ferromagnetic workpiece to tilt such that the extension tube is closer to the surface.

### FIELD

The present specification here relates in general to a sorting apparatus, and more particularly, to an automated apparatus for aligning workpieces.

### BACKGROUND

In today's day and age, it is often impractical to manufacture products manually, especially when a large quantity of identical products are required. Therefore, there has been a transition to automated processes where machines are capable of completing repetitive tasks quickly and efficiently. With the gradual transition of assembly processes from manual process to automated processes, continual developments have been made to handle various workpieces during an assembly process. Such developments allow for automated machines to operate faster and more efficiently than possible when the process is performed manually.

### SUMMARY

In accordance with an aspect of the invention, there is provided an apparatus for aligning a ferromagnetic workpiece. The apparatus includes a rotatable element having a surface. The rotatable element is rotatable about an axis extending from the surface. The apparatus further includes a holding unit for holding the ferromagnetic workpiece toward the surface. In addition, the apparatus includes a rare-earth magnet disposed within the rotatable element. The magnet is configured to engage a portion of the ferromagnetic workpiece within an engagement area on the surface such that the ferromagnetic workpiece is held at a position on the rotatable surface substantially at the center of the engagement area.

The ferromagnetic workpiece may include a cap, a nozzle tube and an extension tube.

The magnet may generate an engagement area.

The engagement area may be substantially the same size as the ferromagnetic cap.

The engagement area may be about 1.0 inches.

The rotatable element may be configured to rotate between about 5 revolutions per minute and 10 revolutions per minute.

The magnet may be disposed proximate to an edge of the rotatable element.

The holding unit may include an angled portion configured to form an angled hopper with the surface of the rotatable element.

The apparatus may further include a protective covering disposed on the magnet. The protective covering may be configured to protect the magnet.

The rotatable element may be circular.

Substantially at the center may include being within 0.075 inches of the center.

In accordance with another aspect of the invention, there is provided an alignment assembly for aligning a ferromagnetic workpiece. The ferromagnetic workpiece includes a cap and a nozzle tube and an extension tube. The alignment assembly includes a support member. The alignment assembly further includes a first bar connected to the support member. The first bar being parallel to a surface rotatable about an axis extending from the surface. The alignment assembly further includes a second bar connected to the support member. The second bar being parallel to the first bar, the first and second bar defining a gap for receiving the nozzle tube, the second bar being further from the rotatable surface. The second bar urges the cap closer to the axis relative to the first bar to cause the ferromagnetic workpiece to tilt such that the extension tube is closer to the surface.

The assembly may further comprise a takeoff track assembly configured for receiving the ferromagnetic workpiece.

The second bar may be thicker than the first bar.

The assembly may further comprise a spacer disposed between the second bar and a mount configured to shift the second bar for tilting the ferromagnetic workpiece.

The second bar may urge the cap closer to the axis relative to the first bar to cause the ferromagnetic workpiece to tilt such that the extension tube is in contact with the surface.

### BRIEF DESCRIPTION OF THE DRAWINGS

Reference will now be made, by way of example only, to the accompanying drawings in which:

FIG. 1 is a front view of an apparatus in accordance with an embodiment;

FIG. 2 is a perspective view of the apparatus in accordance with the embodiment of FIG. 1;

FIG. 3 is a top view of the apparatus in accordance with the embodiment of FIG. 1;

FIG. 4 is a side view of the apparatus in accordance with the embodiment of FIG. 1;

FIG. 5 is a perspective view of a workpiece in accordance with an embodiment;

FIG. 6 is a perspective view of an alignment assembly in accordance with an embodiment;

FIG. 7 is a side view of the alignment assembly in accordance with the embodiment of FIG. 6;

FIG. 8 is a side view of an alignment assembly in accordance with another embodiment;

FIG. 9 is a side view of an alignment assembly in accordance with another embodiment;

FIG. 10 is a front view of a portion of an apparatus in accordance with another embodiment; and

FIG. 11 is a side view of a portion of the apparatus in accordance with the embodiment of FIG. 10.

### DETAILED DESCRIPTION OF THE EMBODIMENTS

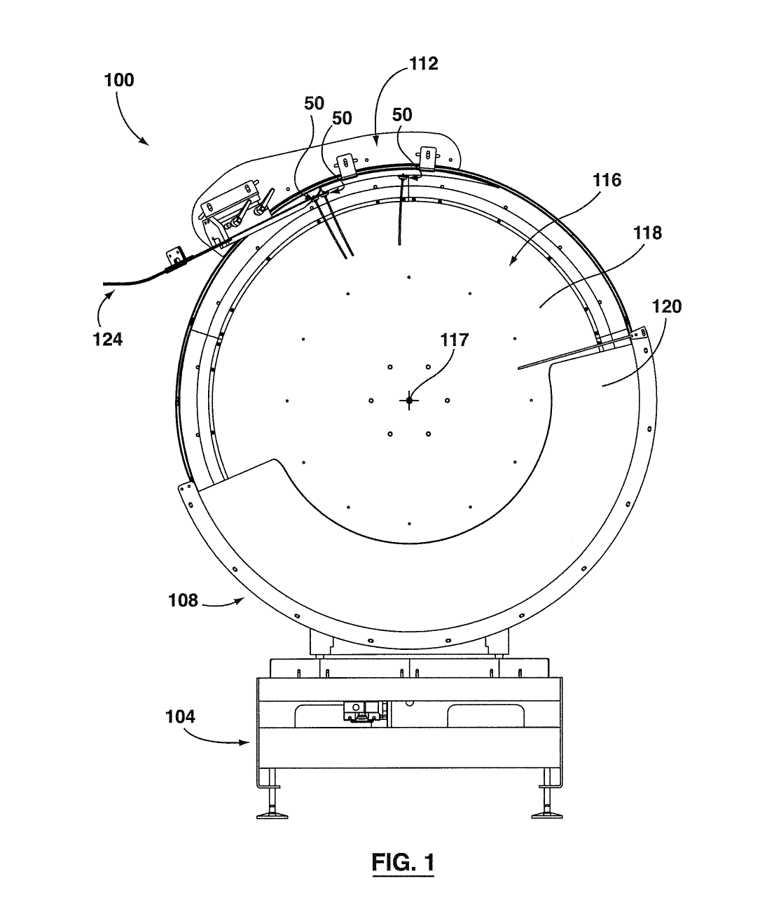

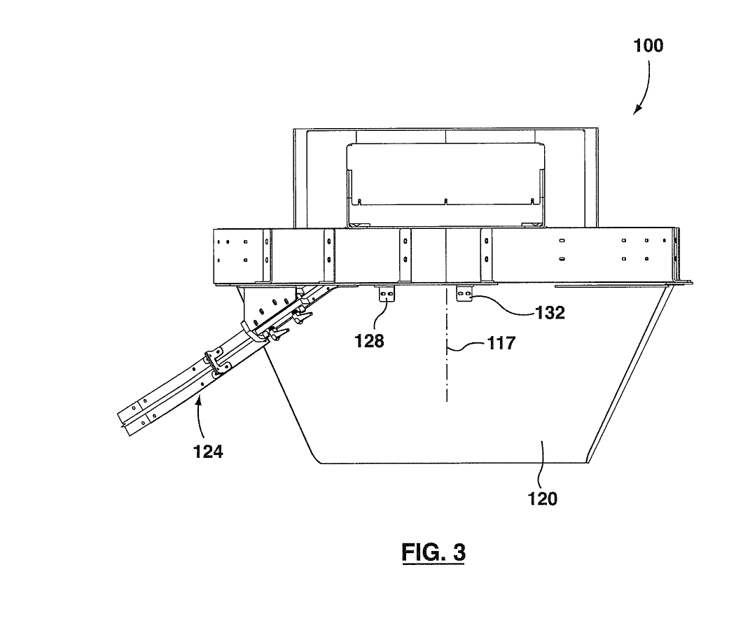

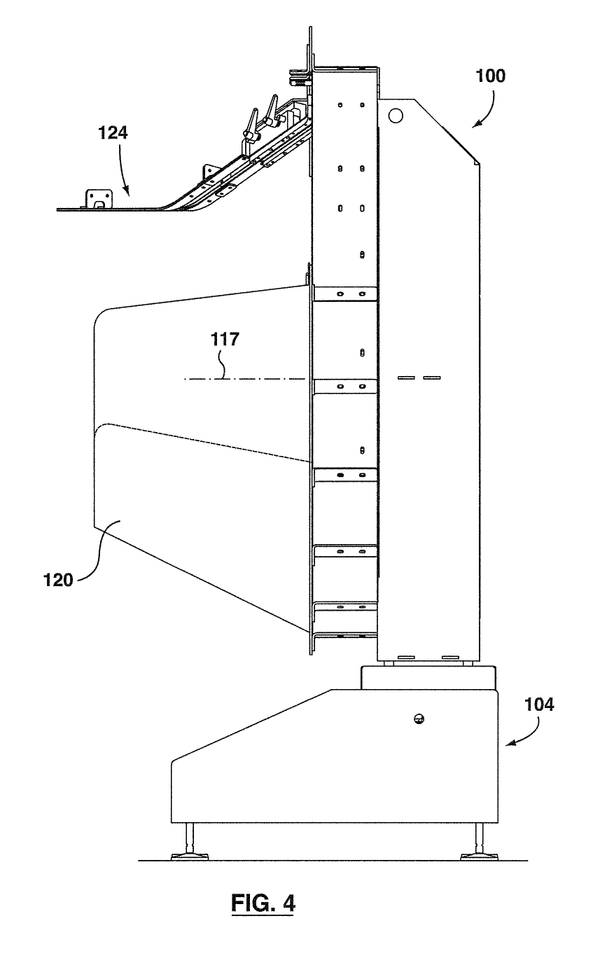

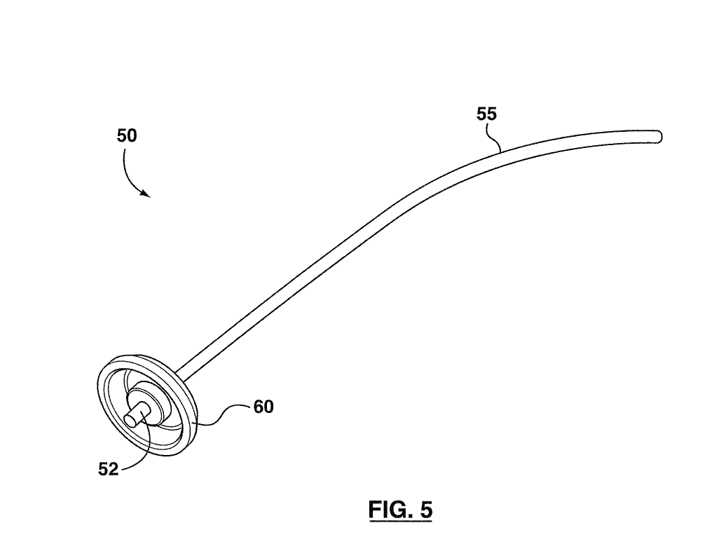

Referring to FIGS. 1 to 4, a representation of an apparatus for aligning ferromagnetic workpieces 50 is shown generally at 100. It is to be understood that the apparatus 100 is purely exemplary and it will become apparent to those skilled in the art that a variety of apparatus are contemplated. The apparatus 100 includes a base 104, a holding unit 108, an alignment assembly 112, and a rotatable element 116. In the present embodiment, the ferromagnetic workpiece 50 is generally shown in FIG. 5. The ferromagnetic workpiece 50 is a valve stem assembly including a plastic a nozzle tube 52, an extension tube 55 and a cap 60. In the present embodiment, the cap 60 comprises a ferromagnetic metal. In other embodiments, the ferromagnetic workpiece 50 can be modified to be any other shape or have another structural configuration so long as at least a portion of the ferromagnetic workpiece includes a ferromagnetic metal.

The base 104 is not particularly limited to any particular structural configuration. The base 104 is configured to support the apparatus 100. In terms of providing physical support, the base 104 is mechanically structured to support the entire apparatus 100, a plurality of workpieces 50, and their associated movements during operation. For example, the base 104 can be bolted to a fixed structure such as a wall, floor, or ceiling. Alternatively, the base 104 can have a mass and a geometry such that when base is free-standing, it will support the entire apparatus 104. In the present embodiment shown in FIGS. 1 to 4, the base 104 is configured to support the weight of the holding unit 108, the alignment assembly 112, the rotatable element 116, and a plurality of workpieces (not shown). In other embodiments, the base 104 can include a moveable cart to provide easy movement of the apparatus 100.

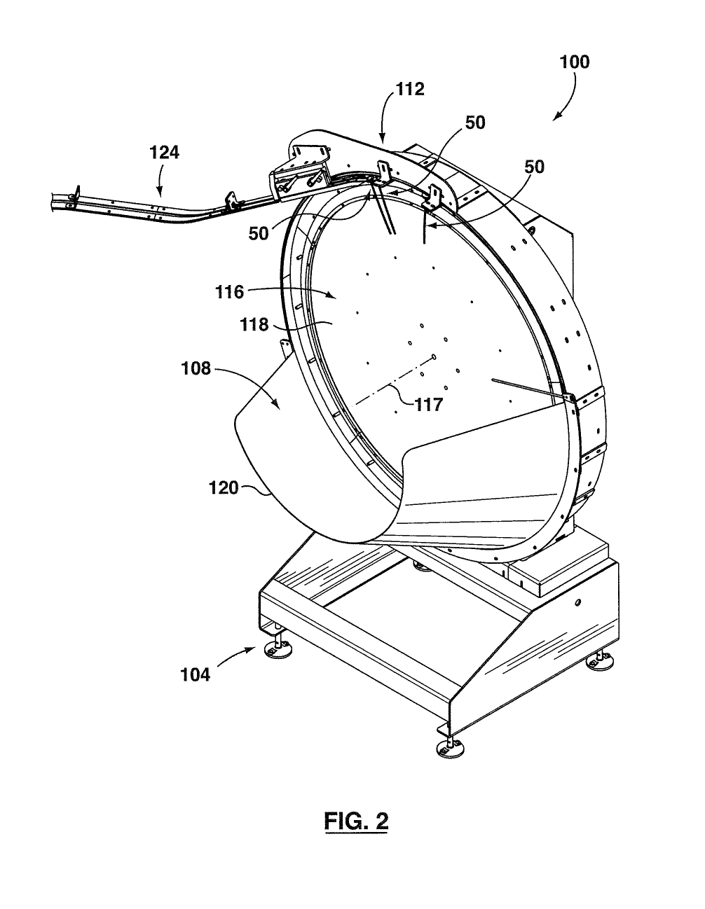

In the present embodiment, the holding unit 108 is generally configured to hold ferromagnetic workpieces 50 for aligning. In the present embodiment, the holding unit 108 includes an angled portion 120 to form an angled hopper as shown in FIG. 2. It is to be understood that the angled portion 120 of the holding unit 108 in the present embodiment is advantageous because workpieces 50 will be urged toward a surface 118 of the rotatable element 116 by the force of gravity. The holding unit 108 is not particularly limited. For example, in other embodiments, the holding unit 108 can be modified to be a container with walls extending substantially perpendicular to the surface 118 of the rotatable element 116.

The alignment assembly 112 is generally configured to align workpieces 50 prior to the apparatus 100 outputting the ferromagnetic workpieces 50. In the present embodiment, the alignment assembly 112 includes a takeoff track assembly 124. The takeoff track assembly 124 allows for easy removal or transfer of the ferromagnetic workpieces 50 from the apparatus 100. It is to be understood that the alignment assembly 112 is not particularly limited to any particular structural configuration. Furthermore, in other embodiments, the takeoff track assembly 124 can be omitted if other means for receiving aligned workpieces 50 are provided.

In general terms, the rotatable element 116 is configured for holding the ferromagnetic workpieces 50 while rotating about an axis 117. The axis 117 about which the rotatable element 116 rotates extends perpendicular from the surface 118 of the rotatable element. However, it is to be re-emphasized that the structure shown in FIGS. 1 to 4 is a non-limiting representation only. In the present embodiment, the rotatable element 116 is circular and the ferromagnetic workpieces 50 are held near the edge of the rotatable element 116 as shown in FIG. 1. In other embodiments, the rotatable element 116 can be modified to be a flexible track moving around any shape and configured to hold workpieces 50 along the track while moving.

In use, the rotatable element 116 is configured to attract a workpiece 50 from the holding unit 108 near an edge of the rotatable element 116 while the rotatable element is rotating about the axis 117. Once the ferromagnetic workpiece 50 is attracted to the rotatable element 116, the rotatable element 116 is configured to hold the ferromagnetic workpiece 50 as the rotatable element 116 rotates. Therefore, the rotatable element 116 transports the ferromagnetic workpiece 50 from the holding unit 108 to the alignment assembly 112 as shown in FIGS. 1 to 4. In the present embodiment, the alignment assembly 112 subsequently aligns the ferromagnetic workpiece 50 and outputs the ferromagnetic workpiece from the takeoff track assembly 124 to another location for another part of an assembly process. Alternatively, for example where the alignment of the ferromagnetic workpieces 50 is the last step of an automated process, the ferromagnetic workpieces can simply be delivered into a box or other storage system that preserves the sorting and alignment after leaving the takeoff track assembly 124.

It will now be appreciated that the apparatus 100 provides a means to sort and align ferromagnetic workpieces 50 in the holding unit 108, where the orientation of the ferromagnetic workpieces is essentially random, and output the ferromagnetic workpieces away from the apparatus 100 in an aligned state.

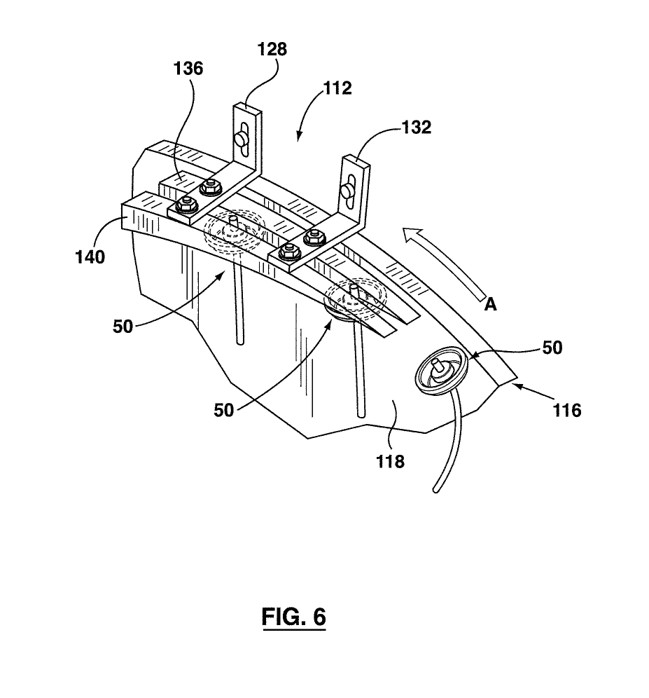

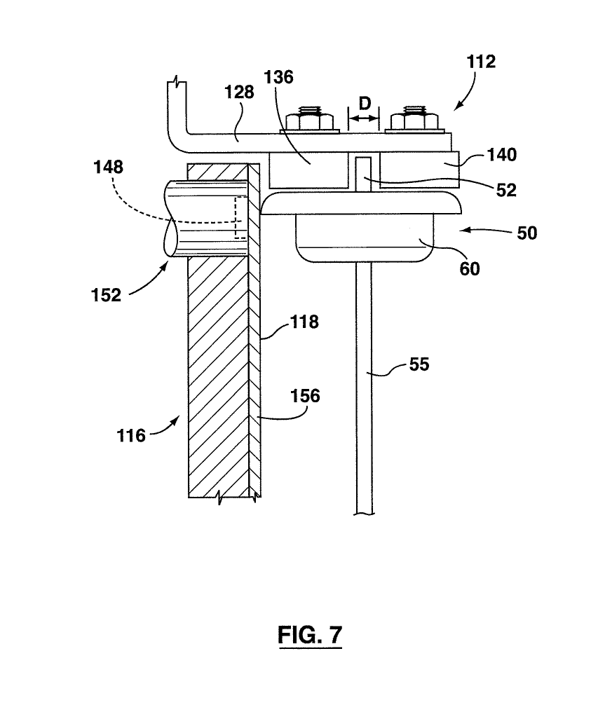

Referring to FIGS. 6 and 7, a portion of an embodiment of the alignment assembly 112 is shown in greater detail. It is to be understood that the alignment assembly 112 is purely exemplary and it will be apparent to those skilled in the art that a variety of alignment assemblies are contemplated including another embodiment discussed in greater detail below. The alignment assembly 112 includes first and second support members 128 and 132, and first and second bars 136 and 140, respectively. In the present embodiment, the alignment assembly 112 also includes a takeoff track assembly 124 (shown in FIGS. 1 to 4). However, as discussed above, the takeoff track assembly 124 can be omitted in other embodiments.

In the present embodiment, the first and second support members 128 and 132 are generally configured to support the first and second bars 136 and 140 in a stationary position relative to the base 104. The first and second support members 128 and 132 are configured to support the first bar 136 such that the first bar 136 is substantially parallel to the surface 118 and proximate to the surface 118. It is to be appreciated that since the rotatable element 116 is configured to move relative to the first bar 136, the first bar 136 is supported such that the first bar 136 is not in contact with the surface 118 to avoid unnecessary frictional wear of the first bar 136 or the surface 118. The first and second support members 128 and 132 are also configured to support the second bar 140 such that the second bar 140 is substantially parallel to the first bar 136. The second bar 140 is disposed further from the surface 118 than the first bar 136. Furthermore, the first and second support members 128 and 132 are configured to support the first and second bars 136 and 140 such that the first and second bars 136 and 140 are separated by a gap having width D as shown in FIG. 7. The width D should be greater than the width of the nozzle tube 52 of a ferromagnetic workpiece 50 such that the gap can receive the nozzle tube 52. Furthermore, the width D should be smaller than the width of the cap 60 of the ferromagnetic workpiece 50 such that the first and second bars 136 and 140 can both contact the cap 60 as the ferromagnetic workpiece is carried through the alignment assembly 112 while being held by a magnet 148 in a magnet holder 152. It is to be understood that the first and second support members 128 and 132 are not particularly limited to any material and that several different types of materials are contemplated. The first and second support members 128 and 132 are typically constructed from materials which are rigid and capable of withstanding the forces applied by the ferromagnetic workpieces. Some examples of suitable materials include stainless steel, plastics, composites and other materials commonly used for support mounts. The exact configuration of the first and second support members 128 and 132 is not particularly limited. In the present embodiment shown in FIG. 6, there are two support members, the first and second support members 128 and 132. In other embodiments, there can be more or less support members. For example, in some embodiments, there can be a single support member. In another example, there can be more than two support members.

The first and second bars 136 and 140 are generally configured to align the ferromagnetic workpiece 50 as the ferromagnetic workpiece is carried through the alignment assembly 112 by the rotatable element 116. As shown in FIG. 6, the first and second bars 136 and 140 are tapered such that as the ferromagnetic workpiece 50 approaches the first and second bars 136 and 140 at the narrower end as the rotatable element 116 rotates in direction A (shown in FIG. 6). The cap 60 contacts at least one of the first and second bars 136 and 140 and is urged toward the axis 117. It is to be understood that the first and second bars 136 and 140 are not particularly limited to any material and that several different types of materials are contemplated. Examples of materials include various metals and alloys, plastics, composites and other material rigid enough to urge the cap 60, when the cap 60 is held at a position on the surface 118. It is also to be re-emphasized that the structure shown in FIGS. 6 and 7 is a non-limiting representation only of the first and second bars 136 and 140. Notwithstanding the specific example with the tapered first and second bars 136 and 140, it is to be understood that other mechanically equivalent structures and can be devised to perform the same function as the first and second bars 136 and 140. For example, the first and second bars 136 and 140 can be modified such that they are of uniform thickness and angled.

In operation, the present embodiment of the alignment assembly 112 aligns the ferromagnetic workpiece 50 as the ferromagnetic workpiece is carried through the alignment assembly 112. The first and second bars 136 and 140 will gradually urge the ferromagnetic workpiece 50 toward the axis 117 of the rotatable element 116 as the ferromagnetic workpiece is carried through the alignment system 112. As the ferromagnetic workpiece 50 is moved from the position where it was held on the rotatable element 116, the cap 60 is aligned by the first and second bars 136 and 140. After reaching the thickest end of the first and second bars 136 and 140, the ferromagnetic workpiece 50 is received by the takeoff track assembly 124 in an aligned state. In the present embodiment shown in FIG. 1, the ferromagnetic workpiece 50 is outputted from a takeoff track assembly 124 where the ferromagnetic workpiece is transported to the next step in the automated assembly process.

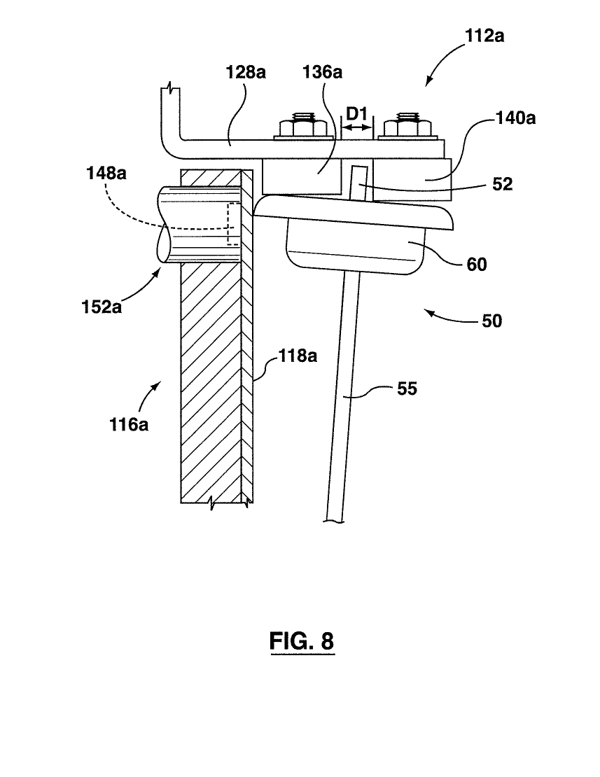

Referring to FIG. 8, a portion of another embodiment of an alignment assembly 112a is shown. Like components of the alignment assembly 112a bear like reference to their counterparts in the alignment assembly 112, except followed by the suffix “a”. The alignment assembly 112a includes a support member 128a, and first and second bars 136a and 140a, respectively. It is to be understood that the alignment assembly 112a and the alignment assembly 112 can be completely interchangeable and can be substituted without any modification to the other components of the apparatus 100. For example, in the embodiment shown in FIG. 8, rotatable element 116a with surface 118a and a magnet 148a in a magnet holder 152a can be identical to the rotatable element 116 with surface 118 and the magnet 148 in magnet holder 152.

In the present embodiment, the support member 128a is generally configured to support the first and second bars 136a and 140a in a stationary position relative to a base (not shown). The support members 128a is configured to support the first bar 136a such that the first bar 136a is substantially parallel to the surface 118a and proximate to the surface 118a. It is to be appreciated that since the rotatable element 116a is configured to move relative to the first bar 136a, the first bar 136a is supported such that the first bar 136a is not in contact with the surface 118a to avoid unnecessary frictional wear of the first bar 136a or the surface 118a. The support member 128a is also configured to support the second bar 140a such that the second bar 140a is substantially parallel to the first bar 136a and further from the surface 118a than the first bar 136a. Furthermore, the support member 128a is configured to support the first and second bars 136a and 140a such that the first and second bars 136a and 140a are separated by a gap having width D1 as shown in FIG. 8. The width D1 should be greater than the width of the nozzle tube 52 of a ferromagnetic workpiece 50 such that the gap can receive the nozzle tube 52. Furthermore, the width D1 should be smaller than the width of the cap 60 of a ferromagnetic workpiece 50 such that the first and second bars 136a and 140a can both contact the cap 60 as the ferromagnetic workpiece is carried through the alignment assembly 112a. It is to be understood that, the support member 128a is not particularly limited to any material and that several different types of materials are contemplated such as materials contemplated for the first and second support members 128 and 132. The exact configuration of the support member 128a is also not particularly limited. In the present embodiment shown in FIG. 8, there are two support members similar to the embodiment shown in FIGS. 6 and 7, the support member 128a and a second support member (not shown). In other embodiments, there can be more or less support members. For example, in some embodiments, there can be a single support member. In another example, there can be more than two support members.

The first and second bars 136a and 140a are generally configured to align the ferromagnetic workpiece 50 as the ferromagnetic workpiece is carried through the alignment assembly 112a by the rotatable element 116a. Similar to first and second bars 136 and 140, the first and second bars 136a and 140a are tapered such that as the ferromagnetic workpiece 50 approaches the first and second bars 136a and 140a from the narrow end. The cap 60 contacts at least one of the first and second bars 136a and 140a and is urged toward the center of the rotatable element 116a. As shown in FIG. 8, it is to be understood that the taper angle of the second bar 140a is greater than the taper angle of the first bar 136a such that the second bar 140a is always thicker than the first bar 136a as shown in FIG. 8. Furthermore, it is to be understood that the first and second bars 136a and 140a are not particularly limited to any material and that several different types of materials are contemplated such as those contemplated for first and second bars 136 and 140.

In operation, the present embodiment of the alignment assembly 112a aligns the ferromagnetic workpiece 50 as the ferromagnetic workpiece is held by the magnet 148a and carried through the alignment assembly 112a. The first and second bars 136a and 140a will gradually urge the ferromagnetic workpiece 50 toward the center of the rotatable element 116a as the ferromagnetic workpiece is carried through the alignment system 112a. As the ferromagnetic workpiece 50 is moved on the surface 118a from a position where it was held on the rotatable element 116a, the cap 60 is aligned by the first and second bars 136a and 140a. After reaching the thickest end of the first and second bars 136a and 140a, the ferromagnetic workpiece 50 is received by a takeoff track assembly (not shown). Since the second bar 140a is thicker than the first bar 136a, the second bar 140a urges the cap 60 closer to the center of the rotatable element 116a than the first bar 136a to cause the ferromagnetic workpiece 50 to tilt such that the extension tube 55 is closer to the surface 118 prior to entry into a takeoff track assembly (not shown). In the present embodiment, the ferromagnetic workpiece is angled such that at least a portion of the extension tube 55 is in contact with the surface 118. In other embodiments, the ferromagnetic workpiece can be only slightly angled such that the extension tube 55 does not contact the surface 118. It is to be appreciated that by angling the extension tube 55 toward the surface, the probability of the ferromagnetic workpiece 50 jamming on the takeoff track assembly is reduced.

It is also to be re-emphasized that the structure shown in FIG. 8 is a non-limiting representation only of the first and second bars 136a and 140a. Notwithstanding the specific example with the tapered first and second bars 136a and 140a, it is to be understood that other mechanically equivalent structures and can be devised to perform the same function as the first and second bars 136a and 140a. For example, the first and second bars 136a and 140a can be modified such that they are of uniform thickness and angled such that the first bar is at a different angle than the second bar.

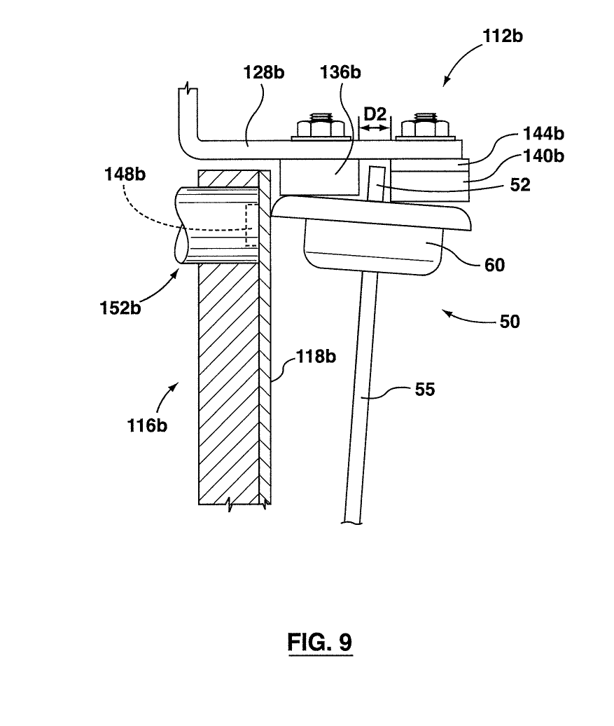

Referring to FIG. 9, a portion of another embodiment of an alignment assembly 112b is shown. Like components of the alignment assembly 112b bear like reference to their counterparts in the alignment assembly 112a, except followed by the suffix “b”. The alignment assembly 112b is quite similar to the alignment assembly 112a and includes a support member 128b, and first and second bars 136b and 140b, respectively. It is to be understood that the alignment assembly 112b and the alignment assemblies 112 and 112a can be completely interchangeable and can be substituted without any modification to the other components of the apparatus 100. For example, in the embodiment shown in FIG. 8, rotatable element 116b with surface 118b and a magnet 148b in a magnet holder 152b can be identical to the rotatable element 116 with surface 118 and the magnet 148 in magnet holder 152.

In the present embodiment, the first and second bars 136b and 140b are similar to each other. However, the alignment assembly 112b includes a spacer 144b between the support member 128b and the second bar 140b to shift the second bar 140b. Therefore, it is to be understood that the operation of the alignment assembly 112b is similar to the operation of the alignment assembly 112a, where the first and second bars 136a and 140a have different taper angles.

Referring to back to FIG. 7, a portion of the rotatable element 116 is shown. In the present embodiment, the rotatable element 116 includes a magnet 148 in a magnet holder 152, and a protective covering 156. It is to be understood that various types of magnets can be used. The magnet holder 152 is designed to facilitate interchanging different types of magnets into the rotatable element by providing a uniform mounting mechanism. In other embodiments, the magnet holder may be integrated with a rotatable element 116 or omitted. For example, in embodiments where the rotatable element 116 is modified to custom fit magnets of uniform size, a magnet holder would not be necessary for magnets of the appropriate size.

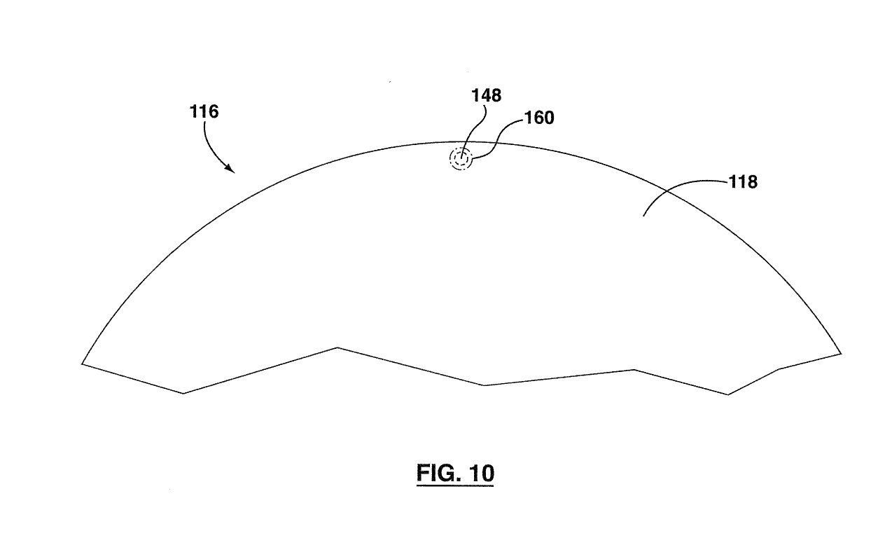

Referring to FIG. 10, the magnet 148 is generally configured to engage the ferromagnetic workpiece 50 when the ferromagnetic workpiece is proximate to an engagement area 160 on the surface 118. In the present embodiment, the engagement area 160 is generated by the magnet 148 and is about the same size as the cap 60, which is about 1.0 inches in diameter. In other embodiments, the engagement area 160 can be larger or smaller depending on the geometry and strength of the magnet. Once the magnet 148 engages the ferromagnetic workpiece 50, the magnet 148 positions the ferromagnetic workpiece 50 such that the ferromagnetic workpiece contacts the surface substantially in the center of the engagement area 160. In the present embodiment, the magnet 148 is a rare-earth magnet. Rare-earth magnets are advantageous for several reasons. For example, rare-earth magnets can exert more force than similarly sized conventional magnets. In the present embodiment, the rare-earth magnet exerts about twice the force as a similarly sized conventional magnet. Another advantage is that, for rare-earth magnets, the attracting force is concentrated closer to the centerline of the magnet. Therefore, the magnet can draw the ferromagnetic workpiece 50 to the centerline of the magnet and hold the ferromagnetic workpiece 50 in a specific position on the surface 118. For example, in the present embodiment using a rare-earth magnet, the ferromagnetic workpiece 50 can be held within about 0.075 inches of the center of the engagement area 160. In other embodiments, the ferromagnetic workpiece 50 can be held over a larger or smaller distance from the center of an engagement area depending on the type of magnet used. It is to be understood that by exerting more force and holding the ferromagnetic workpiece 50 closer to the center of the engagement area, the probability of the ferromagnetic workpiece 50 jamming in the alignment assembly 112 is reduced.

In the present embodiment, the magnet 148 is generally cylindrically shaped with a diameter of about 0.375 inches and a length of about 0.5 inches. In other embodiments, the magnet 148 can be modified to have different diameters. For example, in some embodiments, the diameter of the magnet 148 can be in a range between 0.25 inches and 0.75 inches. In another embodiment, the diameter of the magnet 148 can be in a range between 0.30 inches and 0.70 inches. In yet another embodiment, the diameter of the magnet 148 can be in a range between 0.40 inches and 0.60 inches. Furthermore, the magnet 148 can be further modified to have different lengths. For example, in some embodiments, the length of the magnet 148 can be up to 1.0 inches. In another embodiment, the length of the magnet 148 can be up to 0.80 inches. In yet another embodiment, the length of the magnet 148 can be up to 0.60 inches. In a further embodiment, the length of the magnet 148 can be up to 0.40 inches.

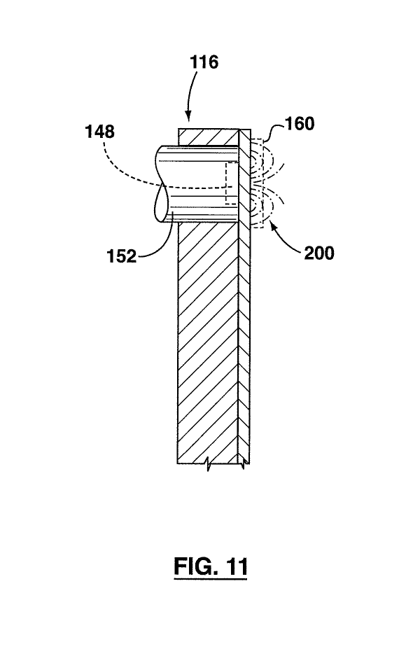

FIG. 11 shows the magnetic field lines of a magnetic field 200 of the magnet 148. It is to be understood that the magnetic field 200 in the present embodiment is strong enough to engage the ferromagnetic workpiece 50 within the engagement area 160. Once the magnet 148 engages the ferromagnetic workpiece, the ferromagnetic workpiece is pulled substantially to the center of the engagement are 160.

In other embodiments, the magnet can be an electromagnet or other types of permanent magnets. The exact configuration of the magnet 148 is not particularly limited. In the present embodiment, the magnet 148 is disposed near an edge of the rotatable element 116. In other embodiments, the magnet 148 can be modified to be positioned closer to the axis 117. Furthermore, although only one magnet 148 is shown in FIG. 10, it is to be understood that a plurality of magnets can be positioned on the rotatable element 116 to increase the number of ferromagnetic workpieces 50 than can be handled by the apparatus 100.

Referring back to FIG. 7, the protective covering 156 is generally configured to provide a wearing surface for protecting the face of the magnet 148. In the present embodiment, the protective covering 156 is a thin sheet of stainless steel. In other embodiments, the protective covering 156 can be other types of metal, plastic, wood, or a paper product. In further embodiments, the protective covering 156 can be omitted such that the ferromagnetic workpieces 50 directly contact the magnet 148 if protection of the face of the magnet 148 is not a concern.

In operation, the holding unit 108 holds a plurality of ferromagnetic workpieces 50 in no particular alignment. As the magnet 148 moves through the holding unit, a ferromagnetic workpiece 50 can enter the engagement area 160. When a ferromagnetic workpiece 50 is within the engagement area 160, the magnet 148 engages the ferromagnetic workpiece 50 and holds the ferromagnetic workpiece at a position on the rotating surface 118 using a magnetic force from the interaction between the ferromagnetic parts of the ferromagnetic workpiece 50 and the magnetic field 200. As the rotating element rotates, the ferromagnetic workpiece 50 will be carried to the alignment assembly 112 for alignment. In the present embodiment, the rotatable element 116 continuously rotates at a variable speed about the axis 117 such that a portion of the rotatable element 116 is within the holding unit 108 as shown in FIG. 1. In the present embodiment, the rotatable element 116 rotates at an optimal rotation speed, which is in the range of about 5 to 10 revolutions/minute. It is to be appreciated that higher speeds of rotation can reduce the probability of engagement and that lower speeds reduce the rate at which ferromagnetic workpieces 50 are aligned. Therefore, although the apparatus 100 will still align ferromagnetic workpieces 50 over a larger range of rotational speeds, a rotation speed outside of the optimal range reduces the efficiency of the apparatus. It is to be understood that changing the magnet strengths, number of magnets, or other parameters of the apparatus changes the optimal rotation speed above. Therefore, in another embodiment, the optimal rotation speed can be in a range between about 1 to 40 revolutions/minute. In yet another embodiment, the optimal rotation speed can be in a range between about 2 to 30 revolutions/minute. In a further embodiment, the optimal rotation speed can be in a range between about 3 to 20 revolutions/minute.

It is to be understood that combinations, variations and subsets of the embodiments and teachings herein are contemplated. As a non-limiting example, the apparatus can include a plurality of alignment assemblies 112, each connected to a separate takeoff track assembly 124. As another non-limiting example the alignment assemblies 112, 112a and 112b can be combined on the same apparatus.

While specific embodiments have been described and illustrated, such embodiments should be considered illustrative only and should not serve to limit the accompanying claims.

What is claimed is:

1. An apparatus for aligning a ferromagnetic workpiece, the apparatus comprising:
a rotatable element having a surface, the rotatable element rotatable about an axis extending from the surface;
a holding unit for holding the ferromagnetic workpiece toward the surface; and
a rare-earth magnet disposed within the rotatable element, the magnet configured to engage a portion of the ferromagnetic workpiece within an engagement area on the surface such that the ferromagnetic workpiece is held at a position on the rotatable surface substantially at the center of the engagement area.

2. The apparatus of claim 1, wherein the ferromagnetic workpiece comprises a cap, a nozzle tube and an extension tube.

3. The apparatus of claim 2, wherein the magnet generates an engagement area.

4. The apparatus of claim 3, wherein the engagement area is substantially the same size as the ferromagnetic cap.

5. The apparatus of claim 3, wherein the engagement area is about 1.0 inches.

6. The apparatus of claim 5, wherein the rotatable element is configured to rotate between about 5 revolutions per minute and 10 revolutions per minute.

7. The apparatus of claim 1, wherein the magnet is disposed proximate to an edge of the rotatable element.

8. The apparatus of claim 1, wherein the holding unit includes an angled portion configured to form an angled hopper with the surface of the rotatable element.

9. The apparatus of claim 1, further comprising a protective covering disposed on the magnet, the protective covering configured to protect the magnet.

10. The apparatus of claim 1, wherein the rotatable element is circular.

11. The apparatus of claim 1, wherein substantially at the center is within 0.075 inches of the center.

12. An alignment assembly for aligning a ferromagnetic workpiece, the alignment assembly comprising:
a support member;
a magnet disposed within a rotatable element having a surface, the rotatable element rotatable about an axis extending from the surface, the magnet having a centerline and the magnet configured to draw the ferromagnetic workpiece to the centerline;
a first bar connected to the support member, the first bar being parallel to a surface rotatable about an axis extending from the surface; and
a second bar connected to the support member, the second bar being parallel to the first bar, the second bar being further from the rotatable surface, wherein the second bar urges a portion of the ferromagnetic workpiece closer to the axis to cause the ferromagnetic workpiece to tilt.

13. The assembly of claim 12, wherein the ferromagnetic workpiece includes a cap, a nozzle tube and an extension tube, and wherein the first and second bar define a gap for receiving the nozzle tube,

14. The assembly of claim 13, wherein the second bar urges the cap closer to the axis relative to the first bar to tilt the ferromagnetic workpiece such that the extension tube is closer to the surface.

15. The assembly of claim 12, further comprising a takeoff track assembly configured for receiving the ferromagnetic workpiece.

16. The assembly of claim 12, wherein the second bar is thicker than the first bar.

17. The assembly of claim 12, further comprising a spacer disposed between the second bar and a mount configured to shift the second bar for tilting the ferromagnetic workpiece.

18. The assembly of claim 14, wherein the second bar urging the cap closer to the axis relative to the first bar to cause the ferromagnetic workpiece to tilt such that the extension tube is in contact with the surface.
